(19) United States
(12) Patent Application Publication
(10) Pub. No.: US 2003/0093323 A1
(43) Pub. Date: May 15, 2003

(54) Information shopping cart for a website

(75) Inventor: Jeffrey D. Kenyon, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International, Inc., Denver, CO (US)

(21) Appl. No.: 09/991,158

(22) Filed: Nov. 15, 2001

(51) Int. Cl. G06F 17/60

(52) U.S. Cl. 705/26

(57) ABSTRACT

An information shopping cart that can be used to store selected information from a website and later use the information at a portable device, such as a personal digital assistant (PDA). The website may be a directory website accessed at a personal computer. The user may select various directory listings, as well as ancillary information (driving directions, maps, advertisements, menus, coupons, etc.) for the information shopping cart. The entire shopping cart is then downloaded to the PDA. The user then takes the PDA where the user needs the information most, whether on the road, walking, or any location away from the personal computer.

### BACKGROUND OF THE INVENTION

The present invention relates generally to systems and methods for transferring information from the world wide web to computing devices, and more particularly to an information shopping cart system and method, which facilitates the information transfer.

Websites are known to offer a “save” feature or other means for selecting desired information from the website and storing it for later reference by the user. For example, a website may provide online telephone and address listings. A user may search for one or more specific listings and place desired listings from the search result into an address book for future reference. When the user returns to the website looking for the same information, the user does not need to perform the search again, but instead can access the information in the address book. The limitation of an address book is apparent when the user needs the information from the website in a different location from where the user has access to the Internet. For example, the user in the example above may need the address listings while away from his/her computer, e.g., when the user has driven to a remote location in a car. However, the user most likely does not have Internet access in the car and thus may not be able to access the information when he/she needs it most.

There are a few options to solve this problem. First, the user could print out the information in the user's address book or the user could make a copy by hand. This method allows the user to take advantage of the quick and easy browsing capabilities of a personal computer. After finding and organizing the information in the address book, the user could take the copy to wherever the information is needed. This method, however, is very inefficient and not cost effective. Copying by hand or printing the information wastes time and paper. Also, the computer's ability to make digital copies of information quickly is wasted.

A second possible solution is to use a portable device that has a wireless Internet connection, such as a web-enabled personal digital assistant (PDA). A portable device can easily be carried in a pocket or purse, allowing the user to access the information wherever the user needs it without carrying a large device. In this situation, the user is not tied down to a desktop computer to retrieve the information. Also, the user is not required to use a laptop computer, which usually does not lend itself to quick and easy use, while the user is moving about, such as in a car or walking. However, the use of a portable device such as a PDA has drawbacks because a portable device does not have the browsing capabilities that a personal computer offers.

In general, web-enabled portable devices are very small to maximize portability. The smaller viewing area makes browsing difficult because of the limited amount of information displayed. Also, the lack of a traditional keyboard makes entering information more cumbersome. Furthermore, the portable device has less memory than a personal computer, limiting the amount of information that can be downloaded from the Internet. Websites that provide content for web-enabled portable devices cannot use HTML due to the constraints of the portable devices. Generally, websites use Wireless Mark-up Language (WML) or Handheld Device Mark-up Language (HDML) as the language for wireless communication with web-enabled portable devices. Due to these constraints, websites provided for web-enabled portable devices are not as content rich as the content provided on a website through a traditional Internet connection by way of a personal computer. Web-enabled portable devices generally are better at providing content that is not large in size, such as email. Due to the difference in languages used and the difficulty in wireless web browsing, many websites do not provide content for wireless web-enabled portable devices. Thus, the user of a web-enabled portable device may not have access to desired information.

Another problem is that many portable devices are not web-enabled. The owners of portable devices that are not web-enabled cannot take advantage of wireless Internet information. Thus, there exists a need in the art for a method and system for combining the browsing ease of a personal computer with the portability of a portable device to provide the user with means to search for and organize information effectively while efficiently keeping the information near the user for use away from the personal computer.

### BRIEF SUMMARY OF THE INVENTION

According to one embodiment the present invention, a user searches for desired information provided by a website on a personal computer using a web browser. The user then selects information items that the user desires to place in an information shopping cart. In one embodiment, the information items are selected by selecting screen options (screen elements or other electronic buttons). Optionally, the information shopping cart may be personalized to the user based on user registration. When the user is finished placing the desired information items in the information shopping cart, the user may download or transfer the information shopping cart to a PDA, remote portable terminal or other suitable computing device. The user then can access the information on the PDA.

A more complete understanding of the present invention may be derived by referring to the detailed description of the invention and the claims, when considered in connection with the figures.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is block diagram of a system which can be used to access an information shopping cart system in accordance with one embodiment of the present invention;

FIG. 2 illustrates one embodiment of a web page, which can be used to search for information items;

FIG. 3 illustrates one embodiment of a web page having results from an information item search;

FIG. 4 illustrates one embodiment of a web page, which can be used to select and store information items in an information shopping cart;

FIG. 5 illustrates one embodiment of a web page that can be used to transfer items from the information shopping cart to a PDA device;

FIG. 6 illustrates one embodiment of a PDA screen showing the completion of an information transfer;

FIG. 7 illustrates one embodiment of a PDA screen showing information items transferred from a web site to the PDA;

FIG. 8 illustrates one embodiment of a PDA screen showing information contained in a selected information item;

FIG. 9 illustrates one embodiment of a PDA screen showing driving directions for a selected information item;

FIG. 10 illustrates one embodiment of a PDA screen showing a coupon for a selected information item; and

FIG. 11 is a flow chart illustrating one embodiment of a method for transferring informational items from a web page to a computing device using an information shopping cart.

### DETAILED DESCRIPTION OF THE INVENTION

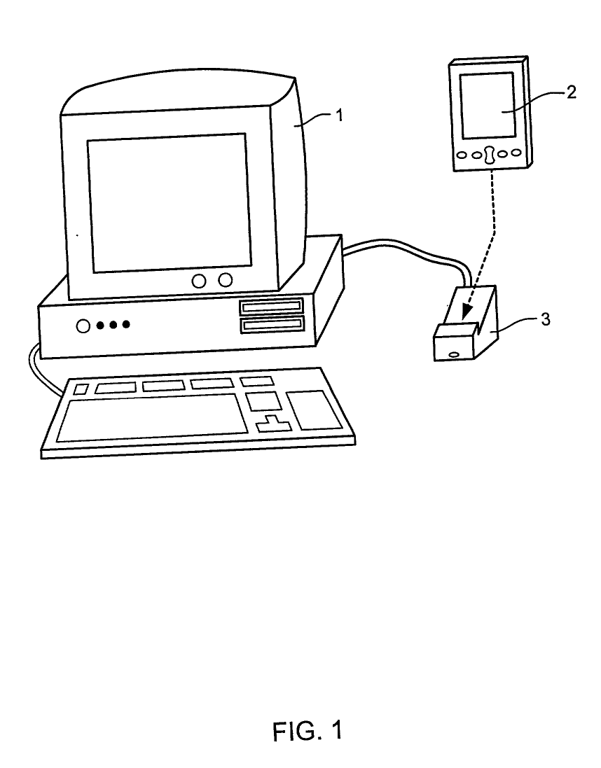

Referring now to FIG. 1, one embodiment of a system that can be used with the present invention is illustrated. The system includes a computer 1, a hand-held device (terminal) or personal digital assistant (PDA) 2, and a PDA connector 3 that provides a direct connection between PDA 2 and computer 1 when PDA 2 is inserted into PDA connector 3. Computer 1 may be any computer that is capable of connecting to the Internet and a PDA, such as a desktop computer, a laptop computer, a server, a workstation, or the like. PDA 2 may be any type of computing device that is portable and is connectable to computer or workstation, such as a Palm OS™ enabled device, a Window CE™ enabled device, or web-enabled portable telephone.

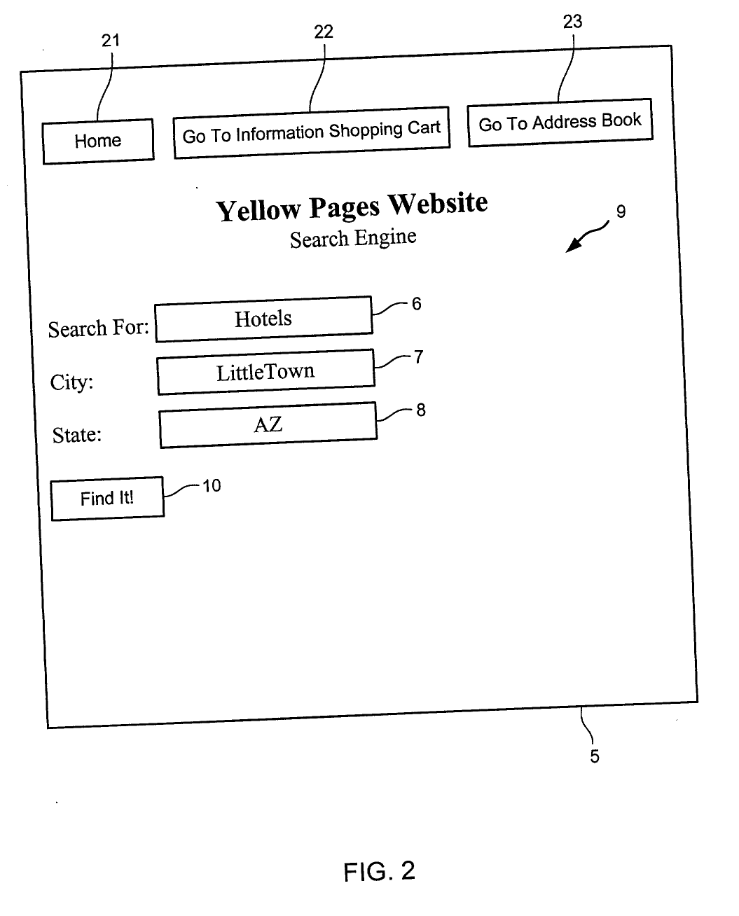

FIG. 2 illustrates one embodiment of an Internet browser window 5 (as displayed at computer 1) used to browse the Internet and the World Wide Web by way of computer 1. In the illustrated embodiment, a directory website offering yellow pages directory services is shown in Internet browser window 5. At the top of the window is a home button 21 (for going to the website home page), a go to information shopping cart button 22 (for going directly to the information shopping cart, which will be described below), and a go to address book button 23 (for going to a personal address book of listings that may have been set up previously by the user). In FIG. 2, a user who has accessed the website has navigated to search engine web page 9 to search for yellow pages listings. In the illustrated embodiment, a user can enter search parameters for a goods/services category 6, a city 7, and a state 8. In this particular example, the user enters “hotels” in goods/services box 6, “LittleTown” in city box 7, and “AZ” for Arizona in state box 8. After the user has entered the search information, the user selects Find It! button 10 to initiate the search.

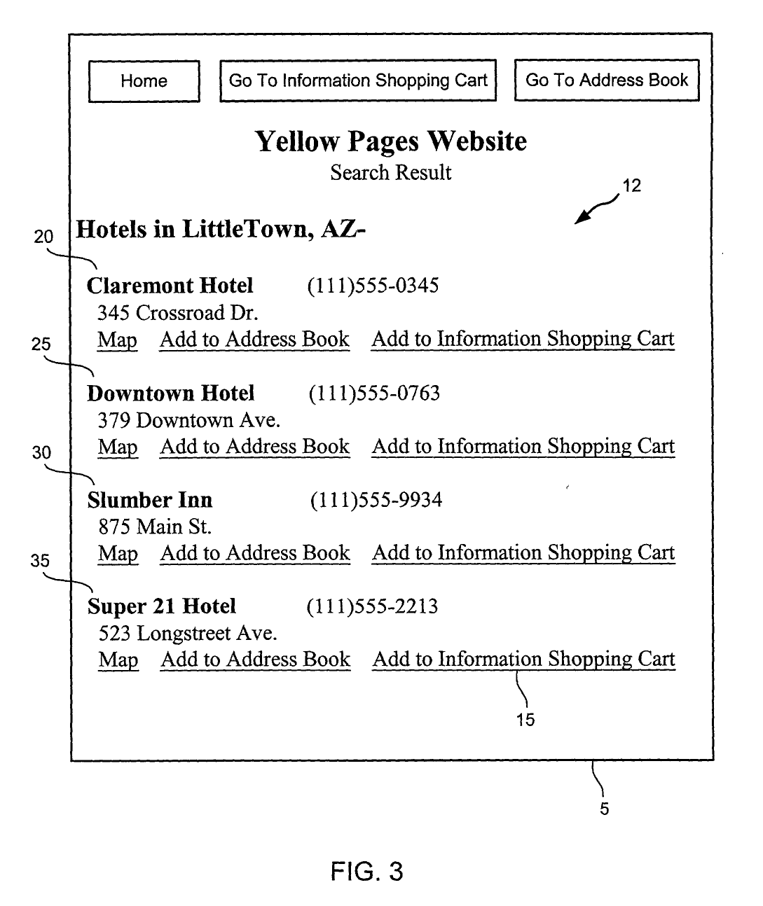

Referring now to FIG. 3, a web page 12 at window 5 illustrates the results of the user's search. Four information items 20, 25, 30 and 35 are returned from the search, each information item providing the name of a hotel along with corresponding address and other contact information. Along with the contact information, an add to information shopping cart option or button 15 is provided with each information item. In this example, the user selects the add to information shopping cart option 15 for the Claremont Hotel information item 20.

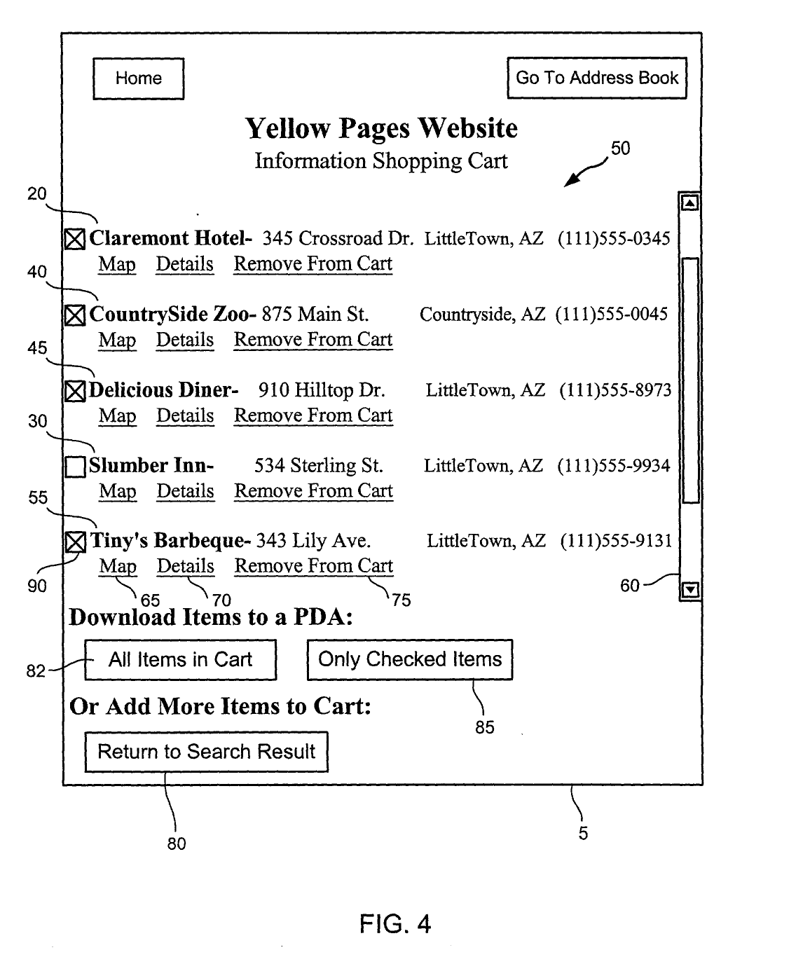

The user is then taken to an information shopping cart webpage 50 as illustrated in FIG. 4. The information shopping cart contains all of the information items that have been previously added by the user during the user's current session. Optionally, the user is allowed to register at the website, allowing the website to store selected information items in the user's information shopping cart from past or for future sessions. In this example, the Claremont Hotel information item 20 has been entered into the information shopping cart. Also, other previously selected information items 30, 40, 45, and 55 are included in the information shopping cart. If the user desires to view more previously entered information items (not shown), the user may scroll up or down the information shopping cart using a scroll bar 60. Optionally, the information items may be organized by categories, such as by hotels, restaurants, recreational locations or other desirable categories.

For each information item in the information shopping cart, the user has a map option 65, details option 70 and a remove from cart option 75. If the user selects the map option 65, the information item's location will be mapped. If the user selects the details option 70, more information regarding the information item will be displayed. The remove from cart option 75 will remove the information item from the user's information shopping cart. A return to search result option 80 is provided in the information shopping cart to allow the user to return to the results of the user's search, as illustrated in FIG. 3, if the user desires to add more information items to the information shopping cart.

The information shopping cart according to the present invention provides the option to the user to download desired information items to a PDA. The user may choose to download the information items by selecting the all items in cart option 82 or the only checked items option 85. If the user selects the all items in cart option 80, all of the information items currently in the information shopping cart will be downloaded to the PDA. Optionally, the user may select an information item by selecting or marking a selection box 90 located next to each information item. This allows the user to keep all of the information items in the information shopping cart while downloading to a PDA only the information items that are selected. If the user selects the only checked items option 85, then only the information items with a mark in the selection box 90 will be downloaded to the PDA.

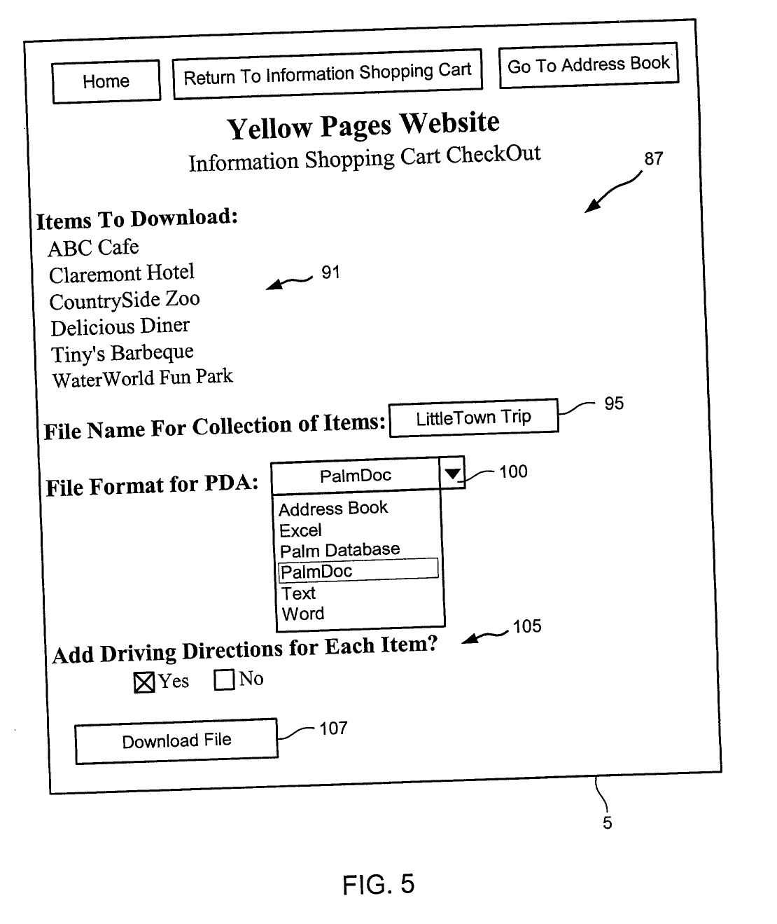

In this example, the user selects the only checked items option 85. The web browser 5 then displays an information shopping cart checkout webpage 87 as illustrated in FIG. 5. Here, an Items to Download list 91 shows the name of each information item that was checked in the information shopping cart. As will be apparent to one of ordinary skill in the art, each information item to be downloaded may contain a variety of information according to the present invention depending on the content provided by the website. Each information item may contain only basic information, such as an address and phone number. Alternatively, each information item may contain a map of the location, driving directions, advertisements for the business, menus for a restaurant, electronic coupons to be used at the business, or other information that would be beneficial to the user. As one option, the directory website could charge an extra fee for a business to place an advertisement or coupon in the business' information item in order to increase the attractiveness of the business to the consumer, and such advertisement or coupon could be automatically included with the information item.

The information shopping cart checkout 87 also allows the user to select a name for the collection of information items to download by entering a file name in a file name box 95. In this example, the user has entered “LittleTown Trip” in file name box 95 as the file name for the collection of information items selected. Next, the user is allowed to select the desired file format for the PDA from a file format menu 100 according to the user's desire. The file format menu 100 may include any file format type that would be desirable for a file download to a PDA. File formats that may be provided include, but are not limited to: Microsoft Excel, Palm Database (PDB), Palm Document (PalmDoc), text file, Microsoft Word, or any other available file format that would be useful to the user. Thus, the present invention provides the user with many options for viewing the information items on the PDA. In this example, the user has selected PalmDoc as the desired file format.

As shown in FIG. 5, the user is allowed to select whether he/she wants driving directions added to each information item by selecting “Yes” or “No” in a driving directions option 105. If the user selects the driving directions option 105, the website may create driving directions to each information item based on the user's address or some other starting location. This location may be set in a user registration profile that may have been previously entered or the user may specify a location after selecting the driving directions option. In alternative embodiments, the user may be provided with further options that can be selectively downloaded in the information shopping cart. Other options that may be provided include, but are not limited to: advertisements corresponding to the information items, electronic coupons for the information item locations, maps of the locations, menus, and/or a list of items for sale at the named business.

When the user is finished selecting the desired options, the user selects the download file option 107. One embodiment of the present invention uses a Java converter to convert the collection of information items to the selected file format. Other types of conversion processes will be apparent to those skilled in the art. Also, branding information for the business that operates/provides the directory website (or the business identified in any information item) may be included in the file, prior to downloading. After the information shopping cart file is converted to the proper format, the file may be downloaded directly to the PDA 2 if the PDA 2 is already in communication with the personal computer 1 by way of the PDA connector 3 and the user has software that allows for a direct download. For example, the user's PDA may be a Palm handheld device that connects with the personal computer 1 by way of a Hotsync connection and uses Palm Conduit software to enable direct downloading. Also, other forms of communication besides a wired connection could be employed (optical, wireless, infrared, etc.). If the PDA is not currently connected to the personal computer 1, the user may save the file on the personal computer 1 and later transfer the file to the PDA 2 when the PDA 2 is connected to the PDA connector 3.

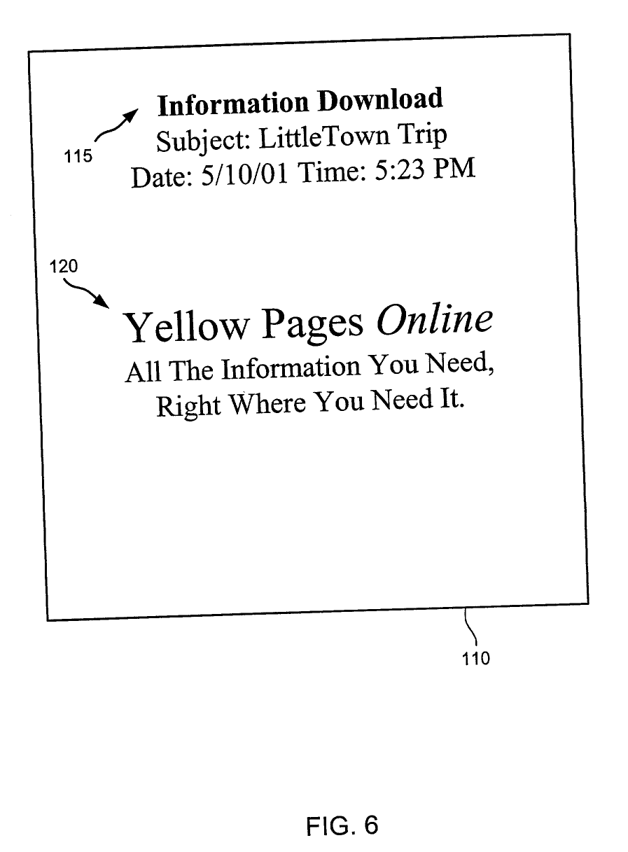

FIG. 6 illustrates a display 110 for the PDA 2. When the information shopping cart file is accessed after downloading is complete, file information 115 is shown on the display 110. Also, branding information 120 may be included to prolong or enhance the connection and relationship that the directory website business has with the user. Here, the branding information 120 includes the name of the website that provided the information, as well as the company's logo. Thus, the present invention provides means for a website provider to maintain a connection with the user long after the user has left the website and terminated the Internet connection. In an alternative embodiment, the company named in any information item may include advertisements in the branding information 120.

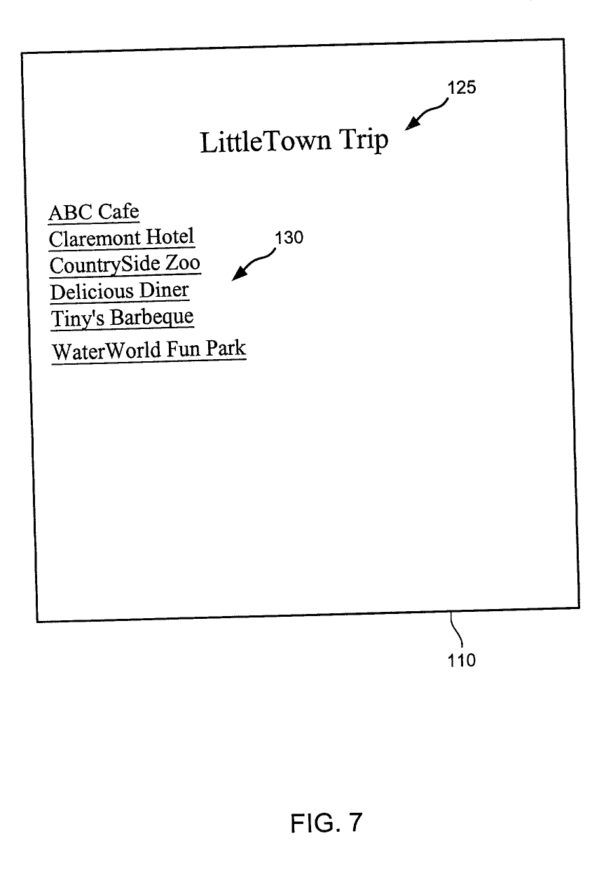

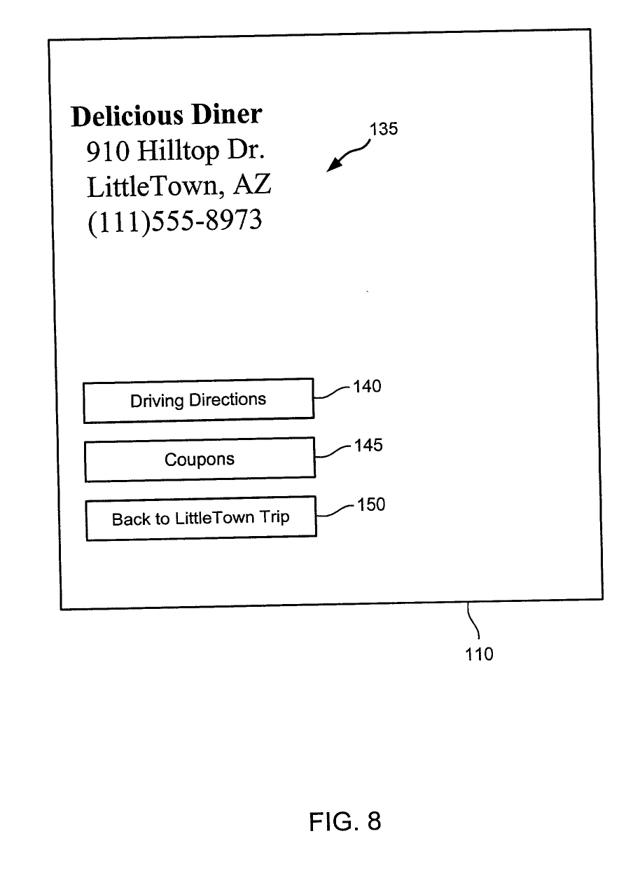

The contents of the information shopping cart file (as seen on the PDA screen 110) are illustrated in FIG. 7. Here, the file name “LittleTown Trip” 125 is shown at the top and a list of contents 130 shows the names of each information item downloaded. Of course, the organization of the file and the content provided may be modified according to the desires of the website provider or the user. When the user selects one of the information items, more information is shown, as in FIG. 8. Here, the user selected “Delicious Diner” from FIG. 7 and the information for the Delicious Diner information item 135 is displayed on the display 110. If the user wants to view the driving directions included with the Delicious Diner information item 135, the user may select a driving directions option 140. Also, the user may decide to view coupons included by selecting a coupons option 145. When the user is finished, the user may return to the “LittleTown Trip” 125 screen by selecting the back to LittleTown Trip option 150. Alternatively, other options may be included based on other information (maps, advertising, etc.) downloaded with the information shopping cart. In this example, the user selects the driving directions option 140.

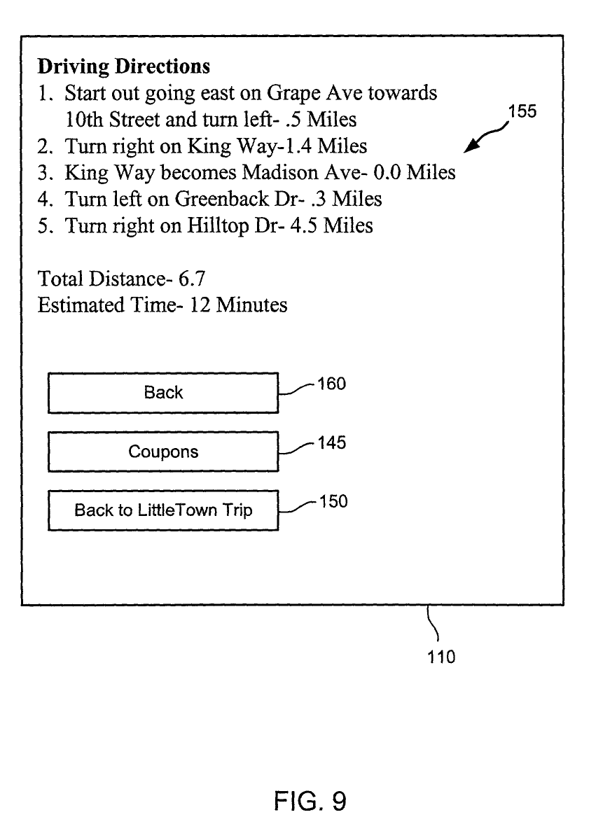

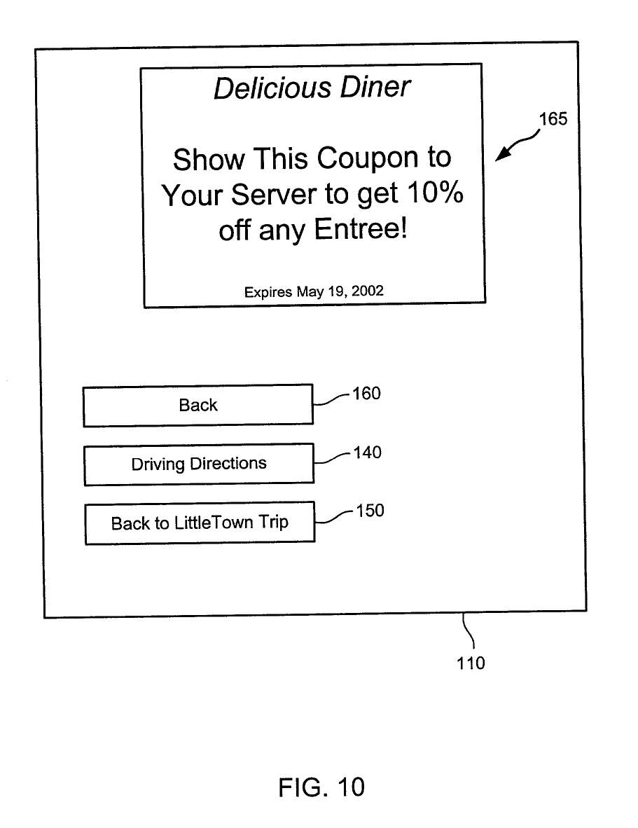

Driving directions 155 are then shown on the display 110, as illustrated in FIG. 9. Next, the user selects the coupons option 145 to view any coupons included with the Delicious Diner information item 135. In FIG. 10, an electronic coupon 165 is illustrated in the display 110. The user may use this coupon by showing the PDA 2 to the server at the restaurant to receive the indicated discount. At each screen, the user can go back to the previous screen by selecting the back option 160.

From the foregoing, it can be seen that the present invention allows the user to easily browse the Internet in order to retrieve and organize information that will later be used away from the personal computer 1. Thus, the user is able to use the more robust browsing capabilities of the personal computer 1 with its ability to retrieve, store and display digital information quickly but still take advantage of the PDA's 2 portability.

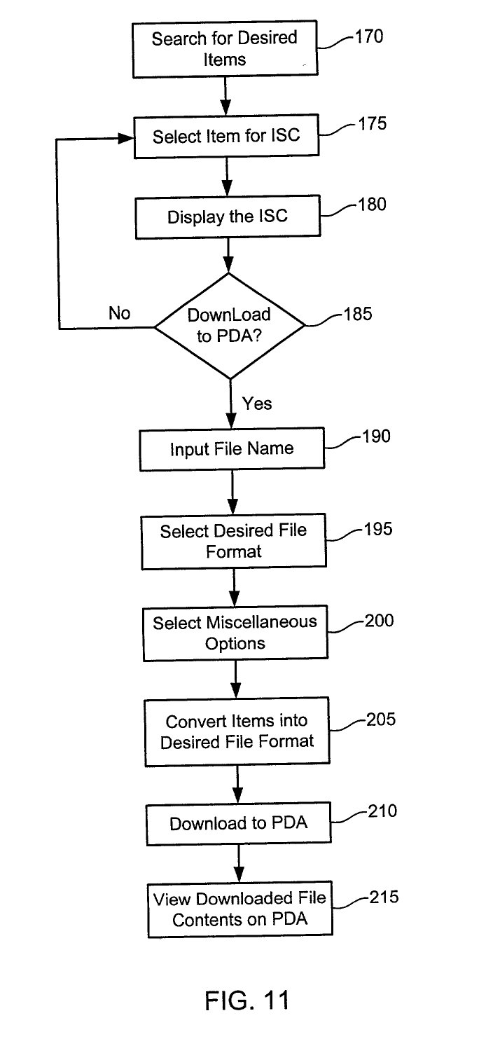

FIG. 11 is a flow chart illustrating one embodiment of a process for searching, selecting, downloading and viewing information items, according to one embodiment of the present invention. At step 170, the user searches for the desired information items from a company's website. Next, at step 175, the user selects an information item from the search result to be placed in the information shopping cart (ISC). The information shopping chart is then displayed for the user at step 180. At step 185, the user chooses whether to download the information items in the information shopping cart to a PDA or to return to the search result to select more information items. If the user chooses to download the contents of the information shopping cart, the user proceeds to step 190 and inputs a file name for the collection of information items. Otherwise, the user returns to step 175.

After inputting the file name at step 190, the user selects the desired file format for the collection of information items at step 195. This option allows the user to select the file format based on user preference or need. Next, at step 200, the user may select miscellaneous options which may include, but which are not limited to, adding driving directions, coupons, menus, a list of items offered, advertisements, maps, or other information that add value to each information item. Alternatively, the miscellaneous options may be included automatically without user selection (and depending on the option, could be selected earlier in the process, but before download). At step 205, the information items, along with selected miscellaneous options and branding information (if provided), are then converted to the file format selected at step 195, such as by using a Java converter. Next, at step 210, the file is downloaded to a PDA. Finally, at step 215, the user views the information items that were downloaded onto the PDA.

As will be apparent to those of ordinary skill in the art, an information shopping cart according to the present invention may be used for a wide range of information items and applications, not all of which are described. Information items that may be useful to place in an information shopping cart and download to a PDA include, but are not limited to: addresses, phone numbers, driving directions, maps, newspaper clippings, coupons, advertisements, listing of items for sale, movie listings, bus/airline/train timetables and any other type of information item that would be useful to allow a user to organize the information items on a computer and download to a PDA for personal use away from the computer.

While a detailed description of present embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for providing information items to a user at a remote portable device, comprising:
accessing the information items at a website;
placing the information items in an information shopping cart at the website in response to selection of the information items by the user; and
transmitting the information shopping cart having the selected information items from the website to the portable device.

2. The method of claim 1, wherein the remote portable device is a personal digital assistant (PDA).

3. The method as in claim 2, wherein the step of accessing comprises:
providing a personal computer having a browser for navigating the Internet in order to use the website; and
displaying information items from the website on the personal computer.

4. The method as in claim 2, further comprising:
displaying, at the PDA and upon request of the user, the information items in the transmitted information shopping cart.

5. The method as in claim 2, wherein the step of accessing further comprises:
searching a database at the website for a set of information items based on a search request from the user.

6. The method as in claim 2, further comprising:
receiving a file name from the user to name the information shopping cart;
transmitting the file name with the information shopping cart to the PDA; and
displaying the file name at the PDA.

7. The method as in claim 2, wherein transmitting the information shopping cart to a PDA further comprises:
converting the information shopping cart at the website to a file format selected by the user.

8. The method as in claim 2, wherein the website is a directory website, and wherein the information items are directory listings.

9. The method as in claim 8, further comprising:
selecting additional information associated with one or more of the directory listings to accompany the directory listings when the information items are transmitted from the website to the PDA.

10. The method as in claim 9, wherein the directory listings include a business name, and wherein the additional information comprises one or more of driving directions, maps, advertisements, menus, coupons and a list of items for sale at the business.

11. The method as in claim 10, further comprising:
automatically placing branding information in the information shopping cart with the information items, so that the branding information is displayed at the PDA with the information items.

12. The method as in claim 11, wherein the branding information identifies the operator of the directory website.

13. A website for access by a user having computer and a PDA coupled to the computer, the website comprising:
a set of information items;
an information shopping cart for storing selected information items;
an add to information shopping cart (add) button associated with each information item; and
a download information shopping cart to PDA (download) button;
wherein an information item is selectively added to the information shopping cart when a user selects the add button associated with that information item; and
wherein the information shopping cart is transmitted to the PDA when the user selects the download button.

14. The website as in claim 13, wherein the add button and the download button are displayed on the computer.

15. The website as in claim 14, further comprising:
a search engine for use by the user in searching for the set of information items.

16. The website as in claim 13, further comprising:
a file name box for display on the computer and for use by the user in entering a file name associated with the information shopping cart and to be displayed at the PDA.

17. The website as in claim 13, further comprising:
a file format box for display on the computer and for use by the user in selecting a file format for the information shopping cart when it is transmitted to the PDA.

18. The website as in claim 13, wherein the website is a directory website, wherein the information items are directory listings, and wherein the website further comprises:
one or more ancillary information buttons, wherein the user selects the ancillary information buttons to add ancillary information to the directory listings in the information shopping cart to be downloaded.

19. The website as in claim 13, wherein the directory listings comprise business names.

20. The website as in claim 19, wherein the ancillary information comprises one or more of driving directions, maps, advertisements, menus, and a list of items for sale.

21. The website as in claim 13, wherein branding information is placed in the information shopping cart before being transmitted to the PDA, so that the branding information is displayed at the PDA with the information items.
